(19) United States
(12) Patent Application Publication
(10) Pub. No.: US 2026/0103597 A1
(43) Pub. Date: Apr. 16, 2026

(54) MINE TAILINGS RECOVERY

(71) Applicant: The Curators of the University of Missouri, Columbia, MO (US)

(72) Inventors: Baolin Deng, Columbia, MO (US); John Earwood, Columbia, MO (US)

(21) Appl. No.: 19/358,556

(22) Filed: Oct. 15, 2025

Related U.S. Application Data
(60) Provisional application No. 63/707,864, filed on Oct. 16, 2024.

(51) Int. Cl. C08L 93/00; C22B 59/00

(52) U.S. Cl. CPC C08L 93/00; C22B 59/00; C08L 2312/00

(57) ABSTRACT

Described herein in various embodiments is a crosslinked ionic imprinted polymer (IIP) for the selective extraction of rare earth metals that can be synthesized through a specific method that involves dissolving chitosan in an alkaline solution to create a dissolved chitosan solution, then freezing and thawing this dissolved chitosan solution. An imprinting solution is subsequently added to the dissolved chitosan solution to form an ionic imprinted solution, which is then cast to obtain an IIP. Finally, a crosslinker is added to the IIP to create a crosslinked IIP.

### CROSS-REFERENCE TO RELATED APPLICATIONS

This application claims priority to U.S. Provisional Application No. 63/707,864 filed on Oct. 16, 2024, the content of which (text, drawings, and claims) is incorporated herein by reference.

### GOVERNMENT RIGHTS

This invention was made with government support under 84065101 awarded by the US Environmental Protection Agency, and G21AP10582 awarded by the US Geological Survey. The government has certain rights in the invention.

### TECHNICAL FIELD

The present teachings relate to mine tailings recovery, and more particularly to an ion imprinted chitosan hydrogel for selective recovery of neodymium and other real earth elements (REEs) from mine tailings and natural acid rock drainage.

### BACKGROUND

Rare earth elements (REEs) exhibit unique magnetic and optical properties arising from their complex electronic structures and sharply defined energy states, making them indispensable components in various high-tech applications. Such applications include permanent magnets, electric vehicles, wind turbines, cell phones, and military defense systems. Among the seventeen REEs, praseodymium (Pr), dysprosium (Dy), terbium (Tb), and neodymium (Nd) account for over 90% of the total economic value, reflecting their critical importance in modern technology. The increasing global demand for these resources, coupled with geopolitical challenges in material acquisition and processing, has created significant supply chain vulnerabilities.

Thus, particular attention has focused on secondary recovery of REEs from mine tailings and acid mine drainage and acid rock drainage. Ion imprinted polymers (IIPs) have emerged as a particularly promising technology for selective separation and recovery of REEs in such contexts, especially in recycling applications, due to their exceptional selectivity at low metal concentrations. Unlike conventional extraction methods such as solvent extraction, ion exchange, and precipitation, IIPs combine extraction and stripping processes simultaneously. Chitosan-based IIPs have garnered significant attention due to their high selectivity and sensitivity, low cost, sustainability, and ease of preparation for metal ion extraction.

However, current chitosan-based IIPs suffer from fundamental limitations that severely restrict their industrial application. Chitosan-based IIPs are developed exclusively from hydrogels regenerated in acidic solutions, resulting in materials that exhibit problematic pH sensitivity, inadequate mechanical strength, poor thermal stability, and low specific surface area. While efforts to address these deficiencies through chemical crosslinking, nanofillers reinforcement, and solid supports have been attempted, such approaches have yielded only moderate enhancements and often sacrifice the beneficial properties that make chitosan attractive for IIP applications. The pH sensitivity is particularly limiting, as many industrial waste streams and natural waters exist at varying pHs ranging from strongly acidic value in acid mine/rock drainages to alkaline conditions, rendering current acidic-dissolution-based chitosan IIPs unsuitable for critical applications.

There is thus a need in the art for novel IIPs that are stable in a wide pH range, in particular in acidic media.

### BRIEF SUMMARY

Described herein is a crosslinked ionic imprinted polymer (IIP) for the selective extraction of rare earth metals that can be synthesized through a specific method that involves dissolving chitosan in an alkaline solution to create a dissolved chitosan solution, then freezing and thawing this dissolved chitosan solution. An imprinting solution is subsequently added to the dissolved chitosan solution to form an ionic imprinted solution, which is then cast to obtain an IIP. Finally, a crosslinker is added to the IIP to create a crosslinked IIP.

The alkaline solution used in this process can be a mixture of one or more bases, urea, and water in a weight ratio of 11.5:8:70. More specifically, the one or more strong bases can comprise LiOH and KOH in a ratio of 4.5:7. When casting the IIP, it can be cast to a thickness between 50 and 200 μm. The crosslinker employed can be a bifunctional crosslinker, such as a homobifunctional electrophilic crosslinker, with specific examples including glutaraldehyde or 1,2,7,8-diepoxyoctane. After crosslinking, the crosslinked IIP can be exposed to a chelating agent to remove the source of rare earth metals, where the chelating agent can be ethylenediaminetetraacetic acid (EDTA). The imprinting solution used in the synthesis can comprise praseodymium, dysprosium, terbium, or neodymium, and in particular embodiments, the imprinting solution comprises NdCl3·6H2O.

The method of synthesizing a crosslinked ionic imprinted polymer follows similar steps, including dissolving chitosan in an alkaline solution to create a dissolved chitosan solution, freezing and then thawing the dissolved chitosan solution, and adding an imprinting solution to the dissolved chitosan solution to form an imprinted polymer solution. This imprinted polymer solution is then cast to obtain an imprinted polymer, and a crosslinker is added to the imprinted polymer to create a crosslinked imprinted polymer. The alkaline solution can be a mixture of one or more strong bases, urea, and water in a weight ratio of 11.5:8:70, where the one or more strong bases comprise LiOH and KOH in a ratio of 4.5:7. The crosslinker can be a bifunctional crosslinker, specifically a homobifunctional electrophilic crosslinker such as glutaraldehyde or 1,2,7,8-diepoxyoctane.

The resulting crosslinked ionic imprinted polymer (IIP) for the selective extraction of rare earth metals comprises a polymer structure with repeating, covalently bonded chitosan monomer units and a plurality of binding sites. These binding sites are voids sized to selectively receive and hold one or more rare earth elements. The polymer structure is reinforced by one or more chemical crosslinkers such that the crosslinked IIP does not dissolve in water.

### BRIEF DESCRIPTION OF THE FIGURES

FIG. 1 exemplarily depicts a generalized synthetic scheme for the crosslinked ion imprinted polymer (IIP) in accordance with various embodiments of the present disclosure.

FIG. 2 exemplarily depicts a schematic depiction of the formation of a binding site in a reinforced IIP in accordance with various embodiments of the present disclosure.

FIG. 3 exemplarily shows the selectivity of the target rare earth element (Nd) over other rare earth elements by an exemplary Nd-imprinted reinforced IIP using real mining waste stream water.

FIG. 4 exemplarily shows the sorption capacity of an exemplary set of reinforced IIPs and chitosan polymers as a function of pH in accordance with various embodiments of the present disclosure.

FIG. 5 exemplarily shows FTIR spectra of AUCH-G, AUCH-D, and control hydrogels that have no ionic imprinting (cAUGH-G and cAUCH-D) in accordance with various embodiments of the present disclosure.

FIG. 6 exemplarily shows thermogravimetric analysis (TGA) spectra of AUCH materials and the corresponding control polymers in accordance with various embodiments of the present disclosure.

FIG. 7 exemplarily shows Nd(III) sorption kinetics and model fitting for AUCH-G and AUCH-D in accordance with various embodiments of the present disclosure.

FIGS. 8A and 8B exemplarily show Nd(III) sorption isotherms and model fitting for AUCH-G and AUCH-D in accordance with various embodiments of the present disclosure.

FIG. 9 exemplarily shows the selective sorption of Nd(III) ions by AUCH materials and corresponding control polymers that have been imprinted by an imprinting solution comprising a neodymium salt in accordance with various embodiments of the present disclosure.

FIGS. 10A and 10B exemplarily show a proposed sorption mechanism of Nd(III) onto AUCH-G and AUCH-D polymers that have been imprinted by an imprinting solution comprising a neodymium salt in accordance with various embodiments of the present disclosure.

FIG. 11 exemplarily shows TGA curves of AUCH materials and control polymer in accordance with various embodiments of the present disclosure.

FIGS. 12A, 12B and 12C exemplarily show kinetics of simultaneous Nd(III) & Pr(III) sorption onto AUCH materials at 25° C. (pH=4, Co=50 ppm Nd:Pr) in accordance with various embodiments of the present disclosure.

FIGS. 13A, 13B and 13C exemplarily show NdPr-AUCH sorption kinetics at various temperatures (pH=4, Co=50 ppm Nd:Pr) in accordance with various embodiments of the present disclosure.

FIG. 14 exemplarily shows the effect of pH on NdPr-AUCH sorption (25° C., Co=50 ppm Nd:Pr) in accordance with various embodiments of the present disclosure.

FIGS. 15A, 15B and 15C exemplarily show sorption isotherms of NdPr-AUCH materials and control polymers at 25° C. (pH=4, Co=10-75 ppm Nd:Pr) in accordance with various embodiments of the present disclosure.

FIGS. 16A, 16B and 16C exemplarily show sorption isotherms of NdPr-AUCH materials at various temperatures (pH=4, Co=10-75 ppm Nd:Pr) in accordance with various embodiments of the present disclosure.

FIG. 17 exemplarily shows simultaneous Nd(III) & Pr(III) uptake in the presence of competing REE species via the NdPr-AUCH materials (pH=4, 25° C., Co=50 ppm for each REE) in accordance with various embodiments of the present disclosure.

FIGS. 18A and 18B exemplarily show NdPr-AUCH sorption capacities & removal percentages for REEs from the Pea Ridge mine acidic drainage in accordance with various embodiments of the present disclosure.

### DETAILED DESCRIPTION

The following detailed description illustrates the claimed invention by way of example and not by way of limitation. This description will clearly enable one skilled in the art to make and use the claimed invention, and describes several embodiments, adaptations, variations, alternatives and uses of the claimed invention, including what is believed to be the best mode of carrying out the claimed invention. Additionally, it is to be understood that the claimed invention is not limited in its applications to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

The term “polymer” as used herein is considered to be inclusive of polymers made from a single repeating monomeric subunit as well as what are commonly called “copolymers,” or polymers made from more than one monomeric subunit. The term “copolymer” is used herein specifically to denote polymers made from more than one type of repeating monomeric subunit. The term “hydrogel” is a kind of polymer that can absorb and retain large amounts of water relative to most polymers.

Described herein are mechanically robust and chemically stable polymers called crosslinked ionic imprinted polymers (IIPs). As is detailed below, the crosslinked IIPs of the present description comprise empty volumes, herein called binding sites, that are sized and shaped to selectively receive and hold specific rare earth metals. The binding sites are introduced during synthesis of the crosslinked IIP in a process called imprinting, also described further below. Control of the imprinting process enables one to produce crosslinked IIPs with binding sites that selectively bind to desired rare earth elements substantially without absorbing and binding other undesired elements. Thus, the crosslinked IIPs of the present description are ideal for selective separation of rare earth elements (REEs).

Several IIPs for the selective separation of REEs are already known in the art, but they are all developed via synthetic methods that begin in acidic solvents. The crosslinked IIPs of the present disclosure differ from the IIPs already known to one of ordinary skill in the art in that their synthesis begins in alkaline solutions. The choice to use alkaline solutions in the synthesis of the crosslinked IIPs of the present disclosure has significant effects on synthetic method and final structure of the crosslinked IIPs, as detailed below.

Structural description of the crosslinked IIPs is necessarily limited, however. Full molecular-level structural characterization of IIPs remains challenging, and structural data on the crosslinked IIPs described suggest a structure that is less ordered than, for example, a typical crystal structure. Therefore, the structure of the crosslinked IIPs described herein is best understood by studying the particular synthetic method that yields the crosslinked IIPs, the molecular components of that method, and well as the performance metrics of the IIPs for selective separation of REEs. Given this insight, the following description of the crosslinked IIPs begins by detailing how they are synthesized.

FIG. 1 shows a general synthetic scheme according to the present disclosure. The following brief description of the general synthetic scheme is followed by a detailed description of each step. Briefly, the general synthetic scheme shown in FIG. 1 begins with dissolving a chitosan powder 10 in an alkaline solution 15 to produce a dissolved chitosan solution 20. The dissolved chitosan solution is frozen, then thawed, and then exposed to an imprinting solution 25 to generate an imprinted chitosan solution 21. The imprinted chitosan solution 21 undergoes a casting process 32, resulting in an ionic imprinted polymer (IIP) 35. The IIP 35 is exposed to a crosslinker 37 and a chelator 38 to produce a crosslinked IIP 40.

The chitosan powder 10 is particularly useful for the synthesis of the crosslinked IIP 40 because it has a chemical structure that includes hydroxyl and amine functional groups, both of which can bind to rare earth element cations.

As shown in FIG. 1, the chitosan powder 10 is dissolved in the alkaline solution 15, resulting in the dissolved chitosan solution 20. The alkaline solution 15 is an aqueous solution comprising one or more basic compounds that cause the pH of the alkaline solution 15 to be greater than 7. The chitosan powder 10 dissolves significantly less readily in a solution with a basic pH than in a solution with acidic pH, so the composition of the alkaline solution 15 and the conditions at which dissolution occurs need to be carefully controlled to fully dissolve the chitosan powder 10. Thus, in various exemplary embodiments, the alkaline solution 15 can be a mixture of LiOH, KOH, urea, and water in a ratio of 4.5:7:8:70, although as detailed below, various alternative formulations and conditions that can be envisioned by one of ordinary skill in the art are considered to be within the scope of the present description.

In various exemplary embodiments, the dissolved chitosan solution 20 can be cooled to a temperature below 0° C. in order to aid in the complete dissolution of the chitosan powder 10. In various exemplary embodiments, the temperature below 0° C. can be between 0° C. and −40° C., between −10° C. and −35° C., or between −20° C. and −30° C. In various exemplary embodiments, the dissolved chitosan solution 20 can be stored at the temperature below 0° C. for an extended period of time, such as 12 hours, before being thawed.

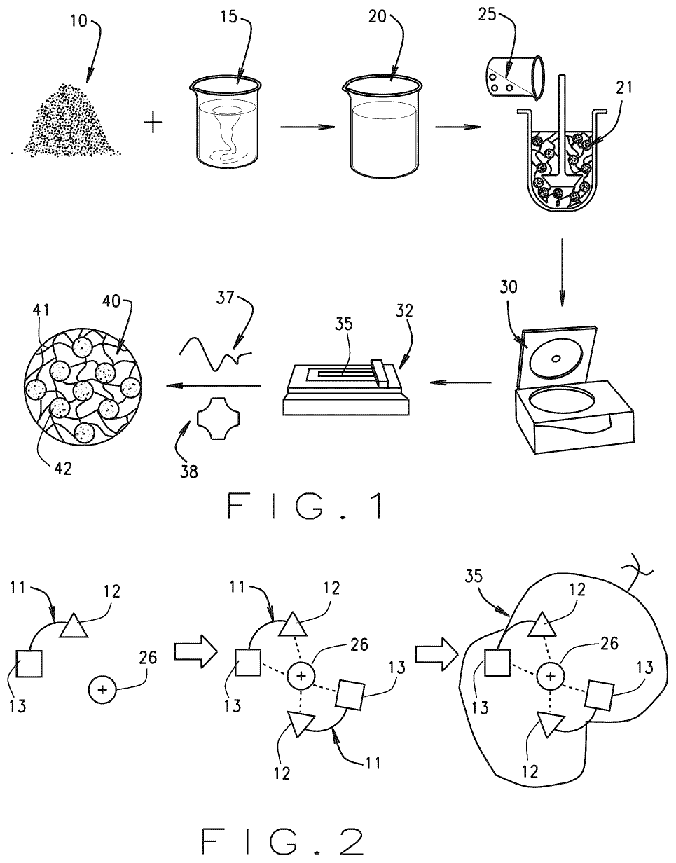

After the chitosan powder 10 is fully dissolved in the dissolved chitosan solution 20, the dissolved chitosan solution is mixed with the imprinting solution 25. In various exemplary embodiments, the imprinting solution 25 can be an aqueous solution comprising a rare earth metal salt. As a non-limiting example, the imprinting solution can be an aqueous solution of a neodymium salt such as NdCl₃·6H₂O, in which case neodymium cations would naturally dissociate into the dissolved chitosan solution 20. The imprinting solution 25 is added as the first step of ‘imprinting’ the dissolved chitosan solution 20 with rare earth metal ions. As shown in FIG. 2, without being bound by any particular theory, when rare earth metal ions 26 mix with the dissolved chitosan solution 20, they form coordination complexes with chitosan molecules 11, particularly via non-covalent interactions (depicted with dashed lines) with amine functional groups 12 and hydroxyl functional groups 13 in the chitosan molecules 11. As a result, in various exemplary embodiments, multiple chitosan molecules 11 form complexes with a single rare earth metal ion 26. The rare earth metal ions 26 thus serve as a collective template around which chitosan molecules 11 arrange themselves spontaneously, forming an imprinted chitosan solution 21.

In various exemplary embodiments, the imprinted chitosan solution 21 can undergo a purification process 30. The purification process 30 serves to maximize mixing of the imprinting solution 25 and the dissolved chitosan solution 20 as well as to remove any impurities that may or may not be present. Thus, in various exemplary embodiments, the purification process can include centrifugation of the imprinted chitosan solution 21 followed by additional mixing. Alternatively, the purification process 30 can proceed according to any suitable method known to one of ordinary skill in the art for enhancing mixing and physically removing impurities.

The imprinted chitosan solution 21 undergoes the casting process 32 to produce the ionic imprinted polymer (IIP) 35. The casting process 32 can be any process known to one of ordinary skill in the art to cast a polymer solution to generate a polymer. Thus, in various exemplary embodiments, the casting process 32 can comprise using a casting knife to produce the IIP 35 at a thickness of 100 μm, and the IIP 35 can be then soaked in a hot water bath at 40° C. for 30 minutes. In various embodiments, after the casting process 32, the IIP 35 can be an Alkali/Urea Chitosan Ion-Imprinted Hydrogel (AUCH).

The IIP 35 does not have the mechanical or chemical stability required for a polymer to be useful in selective REE separation. Chemical crosslinking of the IIP 35 is necessary in order to convert the chitosan IIP 35 into a stable and mechanically robust polymer that can persist in aqueous streams across a wide pH range. Thus, the IIP 35 is exposed to the crosslinker 37 for a period of time under conditions known to one of ordinary skill to result in successful crosslinking of the crosslinker 37 with the IIP 35. The crosslinker 37 can also be any crosslinker known to one of ordinary skill in the art to crosslink a chitosan hydrogel. Thus, in various exemplary embodiments, the crosslinker 37 can be a monofunctional, bifunctional, polyfunctional crosslinker. In various exemplary embodiments, the crosslinker 37 can be a homobifunctional electrophilic crosslinker. In various exemplary embodiments, the crosslinker 37 can be glutaraldehyde, and the IIP 35 can be immersed in a glutaraldehyde solution for two hours. In various exemplary embodiments, the crosslinker 37 can be 1,2,7,8-diepoxyoctane (DEO), and the IIP 35 can be immersed in an alkaline DEO solution at 50° C. for six hours.

After exposure to the crosslinker 37, the IIP 35 still contains rare earth metal ions 26 from the imprinting solution 25, and therefore the IIP 35 is exposed to the chelator 38 to remove the rare earth metal ions 26. The chelator 38 can be any chelating agent known to one of ordinary skill to bind to the rare earth metal ions 26 without deleteriously affecting the structure of the IIP 35. Thus, in various exemplary embodiments, the chelator can be a solution of ethylenediaminetetraacetic acid (EDTA). After exposure of the IIP 35 is exposed to the chelator 38 and the chelator 38 binds to the rare earth metal ions 26, the chelator 38 is rinsed away, leaving the crosslinked IIP 40.

The crosslinked IIP 40 comprises two primary structural components: a crosslinked polymer network 41, which is the result of the polymerization of chitosan and subsequent chemical crosslinking with the crosslinker 37, and a plurality of binding sites 42, which are cavities in the crosslinked polymer network 41 that are sized to selectively receive rare earth metal ions approximately the size of the rare earth metal ions 26 from the imprinting solution 25.

Thus, the crosslinked IIP 40 synthesized according to the general synthetic scheme of FIG. 1 is structured to selectively separate specifically the rare earth metal ions 26 that are in the imprinting solution 25. For example, in various embodiments, the imprinting solution 25 comprises a neodymium salt, and the crosslinked IIP 40 that is synthesized as a result is structured to selectively separate neodymium ions from an input stream by receiving neodymium ions in the binding sites 42. By contrast, in various embodiments in which the imprinting solution 25 does not contain neodymium but instead comprises a dysprosium salt, the resulting crosslinked IIP 40 will comprise binding sites 42 that selectively receive dysprosium ions. Binding sites 42 that are spontaneously structured around specific rare earth metal ions 26 will be significantly less capable of receiving and holding other rare earth metal ions.

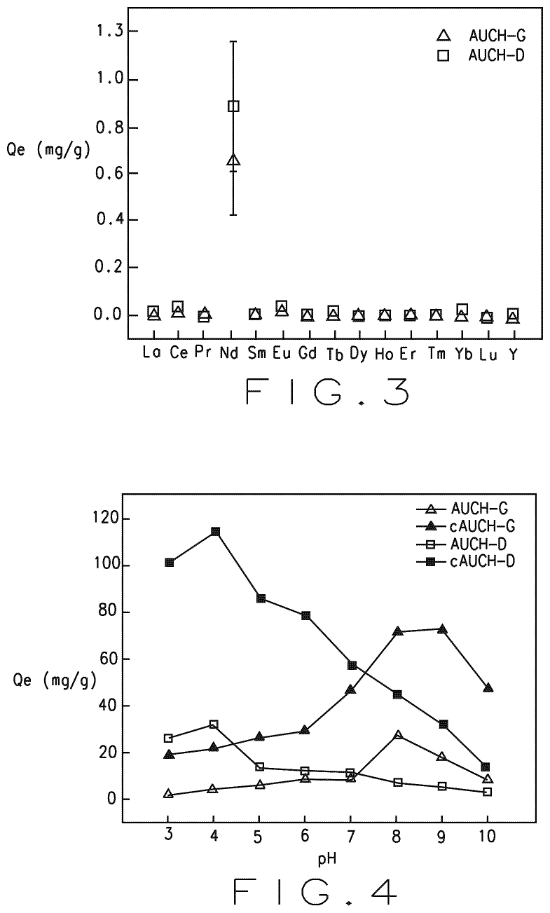

FIG. 3 demonstrates that the crosslinked IIP 40 substantially only bind those rare earth metal ions that are presented in the imprinting solution 25. FIG. 3 compares Nd sorption capacity (capacity to absorb various metal cations) of different exemplary crosslinked IIPs 40. AUCH-G is an exemplary crosslinked IIP 40 that has been crosslinked with glutaraldehyde. AUCH-D is an exemplary crosslinked IIP 40 that has been crosslinked with DEO. For reference, the molecular structures of glutaraldehyde and DEO are depicted below as structures I and II, respectively.

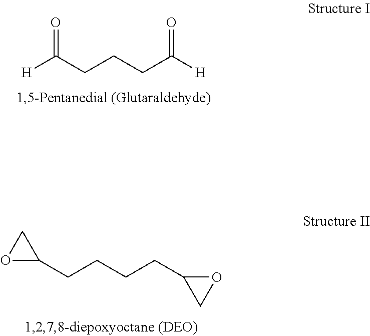 [SMILES: O=CCCCC=O ; C(CCC1CO1)CC1CO1]

In the exemplary embodiments shown in FIG. 3, the imprinting solution 25 to which both AUCH-D and AUCH-G were exposed comprised a neodymium salt. As a result, and as shown in FIG. 3, both crosslinked IIPs selectively absorb significant quantities of Nd, but exhibit substantially lower absorption of the other rare earth metals that were tested. Thus, as described above, the crosslinked IIP 40 of the present description can be tailored via the imprinting solution 25 to selectively absorb and thereby separate particular rare earth metals.

Each of the foregoing synthetic steps impacts the structure of the crosslinked IIP 40. As a consequence, the crosslinked IIPs 40 synthesized according to the general synthetic scheme shown in FIG. 1 benefit from unique physical and chemical characteristics that are not present in IIPs made by other methods known in the art.

For example, the dissolution of the chitosan 10 in the alkaline solution 15 is generally more challenging and labor-intensive than the dissolution of chitosan in acidic solutions, but the resulting hydrogel structure is more mechanically, thermally, and chemically robust. Without wishing to be bound by any particular theory, chitosan dissolved in acidic solutions undergoes gelation driven by deprotonation and rapid neutralization, which causes chitosan chains to physically entangle. The result is the formation of a sol-gel interface and a lack of uniform cross-linking throughout the hydrogel. The rapid physical entanglement of chitosan bonds in acidic solutions leaves the chitosan chains relatively disordered, resulting in a loose, relatively non-homogenous, and mechanically weak polymer. By contrast, chitosan dissolved in alkaline solutions undergoes gelation that is primarily dependent on the formation of intermolecular hydrogen bonds among chitosan chains, which is substantially engendered and supported by the amine and hydroxyl groups in the strong and weak bases in the alkaline solution 25, such as, in various exemplary embodiments, urea, LiOH, and KOH. Chitosan chains then self-assemble into relatively ordered nanofibers. This results in a more compact, homogenous, and mechanically and thermally robust polymer that resists subsequent redissolution.

As the foregoing description demonstrates, although IIPs can often be synthesized more easily by dissolution in acidic solutions than in alkaline solutions, the hydrogels that result from dissolution of chitosan in acidic solutions are too loose, non-homogenous, and rife with voids to selectively separate REEs. The uniform crosslinked polymer network 41 enables and supports consistently sized and distributed binding sites 42 in the crosslinked IIP 40.

Another example of how the above-described synthetic method impacts the structure of the crosslinked IIP 40 can be seen in the crosslinker 37. FIG. 4 tracks sorption capacities of AUCH-D and AUCH-G as well as non-imprinted control polymers cAUCH-D and cAUCH-G across a range of pH values. As can be seen in FIG. 4, AUCH-D exhibits superior sorption capacity at more acidic pH values, with maximum sorption capacity near 4. However, AUCH-D's sorption capacity declines severely at higher pH values. Meanwhile AUCH-G exhibits superior sorption capacity at high pH values near 8 or 9. Without wanting to be bound by any particular theory, the different pH-dependent absorption profiles of AUCH-D and AUCH-G are the result of unique crosslinking mechanisms. The crosslinker DEO comprises highly reactive epoxy groups that readily open in the presence of nucleophiles like the NH₂ and —OH groups of chitosan, forming covalent bonding crosslinks. The covalent bonds are stable crosslinks even at low pH values in which the chitosan is protonated, which enables AUCH-D to maintain high structural stability in low pH environments. Conversely, glutaraldehyde linkages in AUCH-G are looser due to glutaraldehyde's tendency to polymerize via aldol condensation and other side reactions, producing a mixture of monomers, cyclic hemiacetals, and oligomers. While this irregularity can produce sorption in alkaline environments, it also results in looser and more porous networks that are more susceptible to degradation at lower pH ranges. It is important to note that for experiments conducted above pH 7.2, REE(III) can potentially precipitate as REE(OH)₃. This precipitation mechanism could contribute to apparent removal in addition to the absorption process (particularly relevant for AUCH-G). Thus, the crosslinked IIP 40 can be tailored by careful choice of the crosslinker 37 to exhibit particular stability and structure at desired pH ranges, which can change depending on the stream in which REE separation is intended to occur.

The result of the synthetic method described herein is a crosslinked IIP for the selective extraction of rare earth metals. The crosslinked IIP has a polymer structure defined by chitosan dissolved in alkaline media, and therefore, the polymer structure comprises repeating, covalently bonded chitosan monomer units. The polymer structure further includes a plurality of binding sites, which are voids sized to selectively receive and hold one or more rare earth elements. Additionally, the polymer structure is reinforced by one or more chemical crosslinkers, such that the crosslinked IIP does not dissolve in water, is thermally and chemically robust, and resists mechanical degradation.

It is envisioned that in various other embodiments various changes can be made to the above general synthesis that are within the scope of the present description. For example, in various embodiments, the alkaline solution 15 can be a mixture of one or more strong bases, one or more weak bases, and water. In various exemplary embodiments, the one or more strong bases can include NaOH, KOH, LiOH, RbOH, CsOH, Ca(OH)₂, Sr(OH)₂, and/or Ca(OH)₂. In various exemplary embodiments, the one or more weak bases can include NH₃ (urea), RNH₂ (alkylamines), CO(NH₂)₂ (urea), C₅H₅N (pyridine), and/or C₆H₅NH₂ (aniline). In various exemplary embodiments, the alkaline solution 15 comprises LiOH, KOH, urea, and water.

In various exemplary embodiments, the alkaline solution 15 comprises the one or more strong bases, the one or more weak bases, and water in a ratio of 11.5:8:70. In various exemplary embodiments, the alkaline solution 15 comprises the one or more strong bases, the one or more weak bases, and water in a ratio of 9.5:7.5:66, 9.5:7.5:68, 9.5:7.5:70, 9.5:7.5:72, 9.5:7.5:74, 9.5:8:66, 9.5:8:68, 9.5:8:70, 9.5:8:72, 9.5:8:74, 9.5:8.5:66, 9.5:8.5:68, 9.5:8.5:70, 9.5:8.5:72, 9.5:8.5:74, 10.5:7.5:66, 10.5:7.5:68, 10.5:7.5:70, 10.5:7.5:72, 10.5:7.5:74, 10.5:8:66, 10.5:8:68, 10.5:8:70, 10.5:8:72, 10.5:8:74, 10.5:8.5:66, 10.5:8.5:68, 10.5:8.5:70, 10.5:8.5:72, 10.5:8.5:74, 11.5:7.5:66, 11.5:7.5:68, 11.5:7.5:70, 11.5:7.5:72, 11.5:7.5:74, 11.5:8:66, 11.5:8:68, 11.5:8:70, 11.5:8:72, 11.5:8:74, 11.5:8.5:66, 11.5:8.5:68, 11.5:8.5:70, 11.5:8.5:72, 11.5:8.5:74, 12.5:7.5:66, 12.5:7.5:68, 12.5:7.5:70, 12.5:7.5:72, 12.5:7.5:74, 12.5:8:66, 12.5:8:68, 12.5:8:70, 12.5:8:72, 12.5:8:74, 12.5:8.5:66, 12.5:8.5:68, 12.5:8.5:70, 12.5:8.5:72, 12.5:8.5:74, 13.5:7.5:66, 13.5:7.5:68, 13.5:7.5:70, 13.5:7.5:72, 13.5:7.5:74, 13.5:8:66, 13.5:8:68, 13.5:8:70, 13.5:8:72, 13.5:8:74, 13.5:8.5:66, 13.5:8.5:68, 13.5:8.5:70, 13.5:8.5:72, 13.5:8.5:74, 14.5:7.5:66, 14.5:7.5:68, 14.5:7.5:70, 14.5:7.5:72, 14.5:7.5:74, 14.5:8:66, 14.5:8:68, 14.5:8:70, 14.5:8:72, 14.5:8:74, 14.5:8.5:66, 14.5:8.5:68, 14.5:8.5:70, 14.5:8.5:72, 14.5:8.5:74, etc.

In various exemplary embodiments, the imprinting solution 25 can comprise multiple different rare earth metals. For example, in various embodiments, the imprinting solution 25 can comprise a first rare earth metal salt and a second rare earth metal salt. As further example, in various embodiments, the first rare earth metal salt can be neodymium (III) chloride hexahydrate and the second rare earth metal salt can be praseodymium (III) chloride hexahydrate. In such exemplary embodiments, the crosslinked IIP 40 that is formed after exposure to the imprinting solution 25 comprises a plurality of binding sites 42 of at least two different sizes, the at least two different sizes respectively corresponding to the rare earth metal ion in the first rare earth metal salt and the rare earth metal ion in the second rare earth metal salt. An exemplary crosslinked IIP 40 formed after exposure to the imprinting solution 25 comprising multiple different rare earth metals can be therefore capable of selectively absorbing the rare earth metal ions in the imprinting solution 25.

In various exemplary embodiments, the imprinting solution 25 can comprise rare earth metals and/or rare earth metal salts that are not dissolved or otherwise present in a solvent. Thus, despite the name “imprinting solution,” the imprinting solution 25 can, in various exemplary embodiments, merely be dry metal or metal salts.

The crosslinked IIP 40 is stable in media across a wide range of pH values. In various exemplary embodiments, the crosslinked IIP 40 is stable in media from pH 0 to pH 14. In various exemplary embodiments, the crosslinked IIP 40 is stable in media from pH 2 to pH 10. In various exemplary embodiments, the crosslinked IIP 40 is stable in media from pH 3 to pH 7. In various exemplary embodiments, the crosslinked IIP 40 is stable in media from pH 7 to pH 14. In various exemplary embodiments, the crosslinked IIP 40 is stable in media from pH 8 to pH 12. In various exemplary embodiments, the crosslinked IIP 40 is stable in media from pH 2 to pH 6.

### SPECIFIC EXAMPLES

### Example 1: AUCH-G and AUCH-D Synthesis

Materials and Methods: Neodymium (III) chloride hexahydrate (99.9% trace metals basis), glutaraldehyde (50 wt % in water), 1,2,7,8-diepoxyoctane (DEO, 97%), a rare earth element standards mix for inductively-coupled plasma (ICP) analysis (16 elements, 50 mg/L in nitric acid), and low molecular weight chitosan (deacetylated chitin) were all purchased from Sigma-Aldrich (St. Louis, MO, USA). Lithium hydroxide (anhydrous powder), potassium hydroxide (pellets), urea (certified ACS), and ethylenediaminetetraacetic acid (EDTA, ACS reagent) were obtained from Fisher Scientific (Hampton, NH, USA). Additional lanthanide salts including samarium (III) chloride hexahydrate (99%), lanthanum (III) chloride heptahydrate (ACS reagent), and europium (III) chloride hexahydrate (99.9% trace metals basis) were sourced from Sigma-Aldrich. All chemicals were used without further purification. Ultrapure Milli-Q 18.2 MΩ-cm deionized water was used throughout experiments.

Synthesis of Alkali/Urea Chitosan Ion-Imprinted Hydrogel (AUCH). An aqueous solution containing LiOH/KOH/Urea/H2O in a weight ratio of 4.5:7:8:70 was prepared as a solvent for chitosan dissolution under stirring. Chitosan (5% w/w) was added to the slurry and mixed extensively before freezing at −30° C. overnight. A neodymium imprinting solution was prepared by dissolving NdCl₃·6H₂O in ultrapure deionized water (6.67% w/w). The imprinting solution was then added to the thawed chitosan slurry and mixed thoroughly. The prepared slurry was centrifuged at 10,000 rpm for 5 min at 5° C. to remove bubbles and impurities, followed by an additional mixing process. The transparent chitosan solution was then spread on a glass plate and cast to a thickness of 100 μm using a casting knife. Immediately after casting, the glass plate was transferred to a hot water bath maintained at 40° C. and soaked for 30 min, thus forming the neodymium-imprinted chitosan polymer (AUCH).

Crosslinking & Template Removal of AUCH: Two types of imprinted polymers were fabricated using separate crosslinkers: glutaraldehyde and 1,2,7,8-diepoxyoctane. For glutaraldehyde crosslinking, the AUCH was immersed in a 0.01% v/v glutaraldehyde solution for 2 hours. After washing with deionized water, the glutaraldehyde-crosslinked polymer was soaked in 0.05 M EDTA solution overnight for neodymium removal, producing the AUCH-G. For 1,2,7,8-diepoxyoctane (DEO) crosslinking, a procedure similar to what was reported by Vakili et al. (2018) was followed24. First, deionized water was adjusted to pH 10 and heated to 50° C. before thoroughly dispersing DEO to create a 6 g/L solution. The AUCH was then submerged in the DEO solution for 6 hours. After washing with deionized water, the DEO-crosslinked polymer was soaked in 0.05 M EDTA solution overnight for template removal, producing the AUCH-D.

Preparation of Control Materials (cAUCH): Non-imprinted chitosan hydrogels crosslinked with glutaraldehyde (cAUCH-G) and 1,2,7,8-diepoxyoctane (cAUCH-D) were prepared following the same procedures as their imprinted counterparts, but without the addition of Nd (III) or subsequent EDTA elution.

Extraction Performance Evaluation: Batch sorption experiments were conducted in glass jars to evaluate the effects of pH, contact time, initial concentration, competitive sorption, and regeneration on the AUCH-IIPs and their control materials. In a typical experiment, 50 mg of adsorbent was added to 100 mL of Nd (III) solution and mixed at a constant rate of 80 rpm at room temperature. The effect of initial pH on sorption was investigated in the range of pH 3-10, adjusted using 0.1 M HCl and 0.1 M NaOH. Sorption kinetics were studied over a period of 24 hours at pH 7.0. For the sorption isotherm studies, initial Nd (III) concentrations were varied from 10 to 200 mg/L and pH was set at 7.0 and 3.0, respectively, for AUCH-G and AUCH-D, consistent with their optimal pH for Nd (III) sorption. Selectivity was evaluated using multi-component systems containing 50 mg/L each of Nd (III), Eu (III), La (III), and Sm (III) at pH 7. Additionally, selectivity was assessed using real mine drainage waste samples. Alkaline tailings and acid mine drainage samples from the Pea Ridge mine were filtered (0.45 μm) before testing. Based on their relative performance observed in the pure system, AUCH-G was used to extract Nd (III) for alkaline samples and AUCH-D for acid mine drainage. Regeneration studies involved repeated sorption-desorption cycles. After each sorption cycle, the adsorbents were eluted with 0.05 M EDTA and rinsed with deionized water before the next cycle.

Sample Characterization and Analyses: The prepared hydrogels were characterized using various analytical techniques. Surface morphology and elemental composition were examined using an FEI Quanta 600F Environmental Scanning Electron Microscope (ESEM) equipped with a Bruker Energy-Dispersive X-ray Spectroscopy (EDS) system. Fourier Transform Infrared (FTIR) spectra were obtained using a Nicolet 4700 FTIR spectrometer with an Attenuated Total Reflectance (ATR) accessory to identify functional groups and structural changes. Thermal stability and decomposition behavior were analyzed using a Differential Scanning calorimetry-Thermogravimetric Analysis (DSC-TGA) instrument (SDT 600).

For sorption experiments, an ICP-OES Thermo Fischer iCAP PRO was used to determine metal ion concentrations in solution. Samples were prepared by acidification with 2% HNO₃ and filtered through a 0.45 μm membrane. The instrument was optimized for rare earth element (REE) analysis by careful selections of wavelength to minimize spectral interferences. Calibration standards were matrix-matched, and method validation included the use of certified reference materials and method blanks. Inter-element corrections were applied to address spectral overlaps common in REE analysis.

### Results

The morphology and structure of the AUCH-D, AUCH-G, cAUCH-D, and cAUCH-G were investigated using scanning electron microscopy (SEM). The AUCH-G exhibits a highly textured and rough surface with a complex, irregular structure. The surface has numerous folds, wrinkles, and protrusions, creating a high surface area available for sorption. The use of DEO as a crosslinker results in a more open and porous structure compared to the glutaraldehyde crosslinked polymers. The AUCH-D displays a relatively smoother, more uniform surface with less pronounced texture compared to AUCH-G. The control polymers (cAUCH-D and cAUCH-G) exhibit more homogenous surfaces compared to their imprinted counterparts, particularly in the case of cAUCH-D.

The distinct morphological differences between glutaraldehyde and DEO-crosslinked polymers can be attributed to the nature of these crosslinkers. Glutaraldehyde appears to create a more densely crosslinked network, resulting in the highly textured and rough surface observed in AUCH-G. DEO, on the other hand, allows for a more flexible polymer network, leading to the smoother surface seen. EDS analysis confirms the presence of neodymium in the imprinted polymers and its absence in the control polymers.

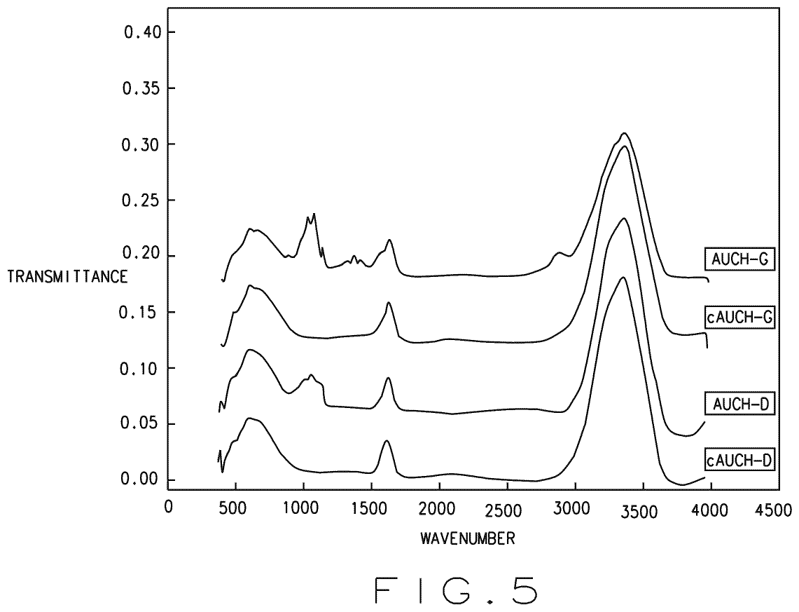

FIG. 5 displays the FTIR spectra of all four polymer samples, including the ion-imprinted polymers (AUCH-G and AUCH-D) and their non-imprinted counterparts (cAUCH-G and cAUCH-D). The broad band at 3375 cm⁻¹ is attributed to O—H and N—H stretching vibrations, characteristic of the chitosan backbone. The peak at 1640 cm⁻¹ corresponds to C═O stretching of the amide I band. The peaks at 695 and 601 cm⁻¹ likely represent N—H out-of-plane bending and pyranose ring deformation modes, respectively, indicating the intact chitosan structure across all samples. Distinct peaks at 1150, 1079, and 1032 cm⁻¹ observed exclusively in the IIP samples likely represent a combination of C—O, C—N, and Nd—O interactions, suggesting successful incorporation of neodymium ions and formation of specific binding sites. The peak at 2903 cm⁻¹ for AUCH-G can be assigned to C—H stretching vibrations, possibly enhanced due to neodymium imprinting and additional CH₂ groups from glutaraldehyde crosslinking. The enhancement in peak intensity at 1079 and 1032 cm⁻¹ in both AUCH samples suggests a higher degree of ordered structure due to neodymium templating. The FTIR analysis provides strong evidence for successful neodymium imprinting in both AUCH-G and AUCH-D samples.

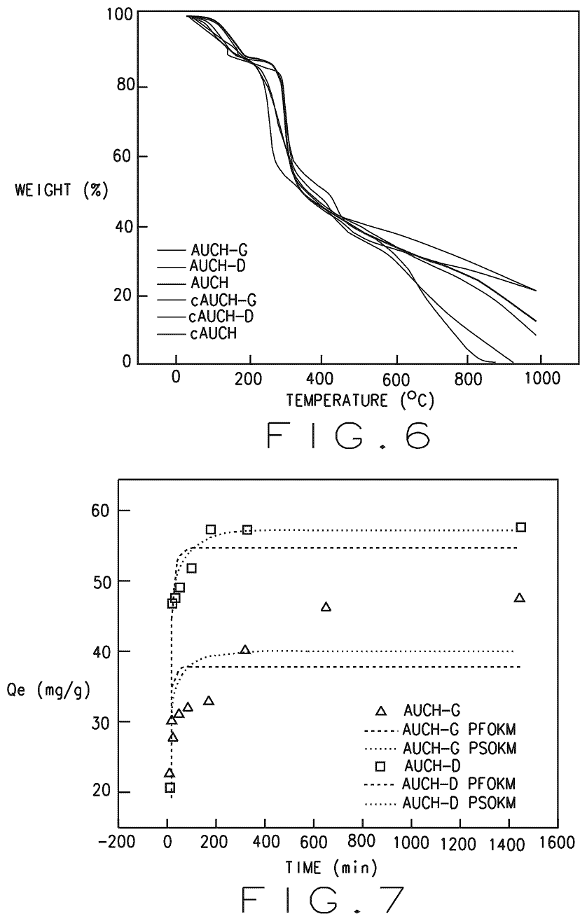

Thermogravimetric Analysis (TGA) was performed to evaluate the thermal stability of the synthesized chitosan-based imprinted hydrogels FIG. 6. All samples exhibited an initial weight loss between 25-200° C. and 250-350° C., attributed to bound water evaporation, followed by a more pronounced degradation stage between 200-400° C., likely corresponding to chitosan backbone decomposition. Previous work has shown that molecular weight and degree of deacetylation are important factors affecting the thermal stability of chitosan. At a temperature higher than ˜500° C., the imprinted polymers demonstrated higher thermal stability compared to their non-imprinted counterparts. At 1000° C., AUCH-D and AUCH-G maintained the highest residual masses of ˜22%, while AUCH showed a residual mass of approximately 13%. These results indicate that both the neodymium imprinting process and the choice of crosslinker influence the thermal stability of chitosan-based polymers and are consistent with the non-volatile nature of Nd.

Characterization of Mine Waste Samples: The Pea Ridge deposit in Washington County, Missouri, is a significant iron ore resource that also contains high concentrations of rare earth elements. It is part of the Middle Proterozoic volcano-plutonic complex in the St. Francois terrane. The deposit includes several mappable units, with four lanthanide-bearing breccia pipes that cross-cut the magnetite-hematite ore body. This unique geological setting makes the Pea Ridge mine an important site for studying REE distributions in both alkaline tailings and acidic mine drainage. 2 L of liquid samples were taken from the alkaline tailings lake (pH=7.7) and acidic mine drainage ponds (pH=3.6), respectively. The REE distributions in the alkaline tailings pool and acidic mine drainage samples from the Pea Ridge mine were characterized via ICP-OES. The acidic drainage showed higher concentrations of REEs compared to the alkaline pool, with notable peaks for Nd, Eu, and Tb. Both samples exhibited similar distribution patterns, with light REEs present in higher concentrations than heavy REEs.

Efficiency of Nd (III) Extraction by IIPs: The sorption kinetics of Nd (III) on the AUCH-G and AUCH-D were investigated at pH=7 for 0-1440 minutes. As shown in FIG. 7, the sorption on both polymers increased rapidly with AUCH-D reaching equilibrium at 200 minutes, while AUCH-G required 800 minutes to achieve equilibrium. AUCH-D shows higher sorption capacity and faster initial sorption rate compared to AUCH-G. Pseudo-first order (PFOKM) and pseudo-second order (PSOKM) kinetic models were applied to experimental data to elucidate sorption kinetics. The R² value for the PSOKM model is much higher than the PFOKM model for both AUCH-G and AUCH-D, implying the PSOKM model is appropriate for describing sorption data (Table 1). These results suggest chemisorption is the rate-controlling step in the sorption process, with the number of active sites on the adsorbent determining the reaction rate. The ion-imprinted cavities, along with chitosan functional groups, likely contribute to the chemical interactions responsible for the selective sorption of Nd (III).

TABLE 1
PFOKM and PSOKM parameters of AUCH-G and AUCH-D

| | | | | PSOKM | | | | |
|---|---|---|---|---|---|---|---|---|
| | PFOKM | | | | k₂ | h | | |
| | Qe, c | k₁ | | Qe, c | (mg · g⁻¹ | (m · g⁻¹ | t^{1/2} | |
| Hydrogels | (mg · g⁻¹) | (min⁻¹) | R² | (mg · g⁻¹) | min⁻¹) | min⁻¹) | (min) | R² |
| AUCH-G | 37.827 | 0.136 | 0.970 | 40.355 | 0.025 | 0.139 | 5.650 | 0.997 |
| AUCH-D | 54.820 | 0.127 | 0.797 | 58.017 | 0.017 | 0.092 | 5.370 | 1.000 |

Effect of pH on Sorption Performance: The sorption performance of AUCH-G and AUCH-D, along with their corresponding control polymers, was investigated under varying pH conditions. As shown in FIG. 4, AUCH-D exhibited superior sorption capacity in acidic media, with a peak at pH 4 and a maximum sorption rate of 114.91 mg/g. In contrast, AUCH-G showed increasing sorption capacity with increasing pH, reaching a maximum of 72.74 mg/g at pH 9. The imprinted polymers demonstrated significantly higher sorption capacities compared to their non-imprinted counterparts across the pH range studied.

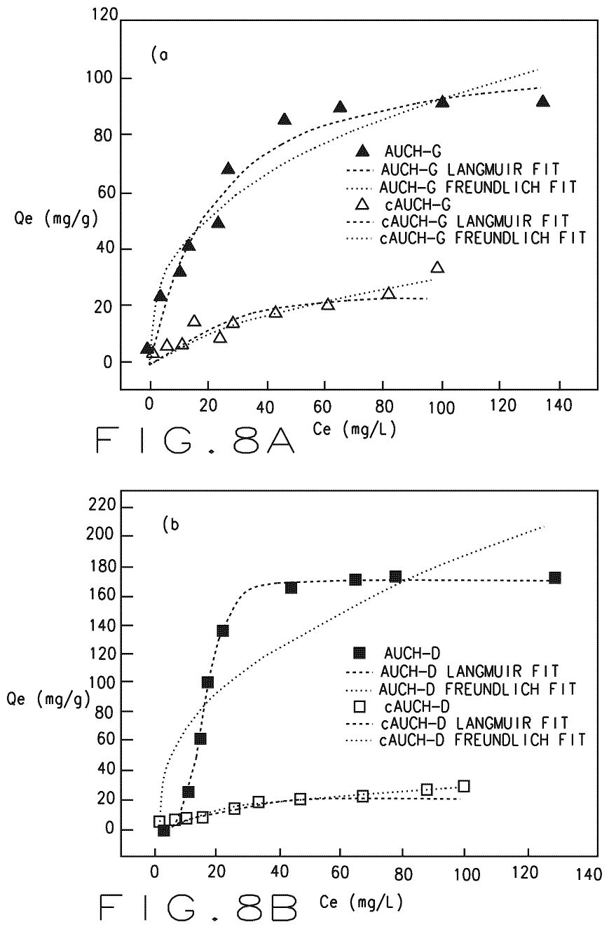

Sorption Isotherm: The sorption isotherms of Nd (III) on AUCH-G and AUCH-D and their control polymers were determined with an initial Nd (III) concentrations ranging from 10 to 200 mg/L at pH 7 and pH 3 for AUCH-G and AUCH-D, respectively. The experimental data were fitted with the Langmuir and Freundlich isotherm models, and the results are presented in FIGS. 8A and 8B. AUCH-D exhibited the highest sorption capacity (174.7 mg/g), followed by AUCH-G (92.46 mg/g) at an initial Nd (III) concentration of 200 mg/L. The R² values suggest that the Langmuir model better described the sorption behavior of Nd (III) on the imprinted polymers (R²>0.96), consistent with a monolayer sorption process on homogeneous surfaces (Table 2). The control polymers show slightly better fit with the Freundlich model, particularly cAUCH-D. The results suggest a stronger affinity between Nd (III) and the binding sites in AUCH-D, while AUCH-G outperforms all polymers at lower Nd (III) concentrations.

TABLE 2
Related Parameters of Langmuir and Freundlich isotherm fitting

| | | | | Freundlich | | |
|---|---|---|---|---|---|---|
| | Langmuir | | | Isotherm Equation | | |
| | Isotherm Equation | | | | KF | |
| | | Qm | KL | | (mg · g⁻¹) | |
| Hydrogels | R² | (mg · g⁻¹) | (L · mg⁻¹) | R² | (L · mg⁻¹)^{1/n} | 1/n |
| AUCH-G | 0.9618 | 109.2 | 0.0635 | 0.9156 | 17.37 | 0.368 |
| cAUGH-G | 0.8726 | 34.43 | 0.0725 | 0.9193 | 0.52 | 0.635 |
| AUCH-D | 0.9991 | 174.3 | 11.41 | 0.7699 | 0.43 | 2.606 |
| cAUCH-D | 0.8491 | 31.90 | 0.1783 | 0.9802 | 0.53 | 0.565 |

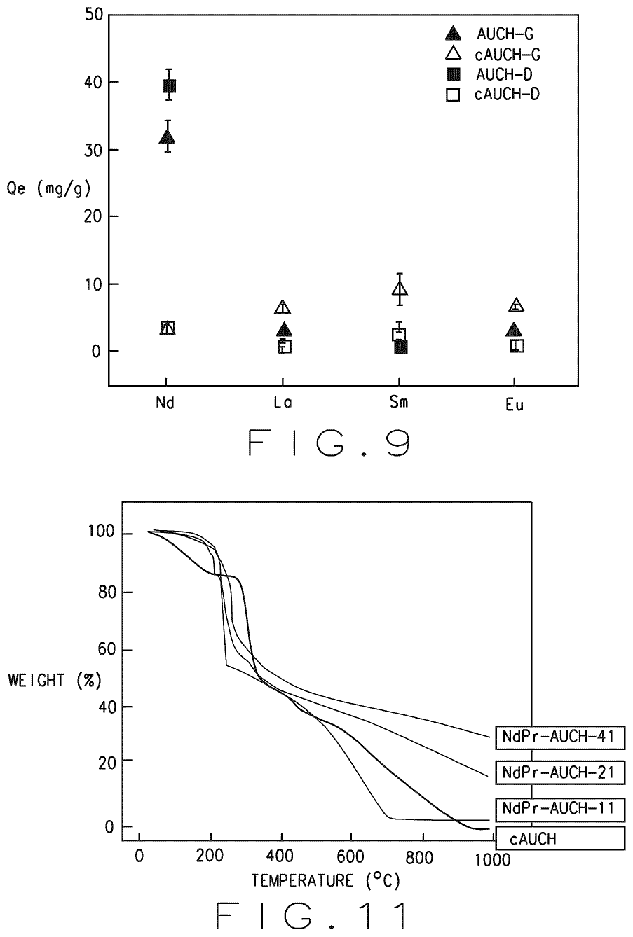

Competitive Sorption: The selective recognition of Nd (III) by AUCH-G and AUCH-D was investigated through competitive sorption experiments in the presence of interfering ions La (III), Sm (III), and Eu (III). Each polymer was added to a solution (pH=7) containing 50 mg/L of each metal ion (Nd (III), La (III), Sm (III), and Eu (III)) to evaluate the selectivity. FIG. 9 shows AUCH-D exhibited the highest sorption capacity for Nd (III) (42.08 mg/g), followed by AUCH-G (36.60 mg/g), while capacities for the interfering ions were significantly lower. For all inferring ions there is no major difference between the imprinted and control materials. These results, along with high selectivity for Nd (III), demonstrate the effectiveness of the imprinting process in creating specific Nd (III) recognition sites in both hydrogels.

Neodymium Removal from Pea Ridge Mine Samples: The chitosan-based imprinted polymers demonstrated high efficacy for Nd (III) recovery from real mine waste leachate samples. AUCH-G achieved 98.69±0.96% Nd (III) removal from alkaline tailings, reducing concentrations from 400±96 ppb to 4.67±4.3 ppb. In the acidic drainage, AUCH-D removed 85.16±4.89% of Nd (III), lowering levels from 447±142 ppb to 70±3.0 ppb. Sorption capacities for various REEs are shown in FIG. 3. The capacities are limited by low initial concentrations in the mine waste media. These results demonstrate the robustness of the chitosan-based imprinted polymers for selective Nd (III) recovery across varied pH environments in complex, multi-element mine waste solutions. The removal performance aligns closely with previous findings in synthetic wastewater, indicating strong potential for practical neodymium recovery applications.

Reusability Studies: The regeneration performance of AUCH-G and AUCH-D are crucial factors for practical application in the recovery of Nd (III) from aqueous solutions. Sorption-desorption experiments were conducted for five consecutive cycles at an initial Nd (III) concentration of 50 mg/L and pH 7. After each sorption cycle, the polymer was eluted with 0.05 M EDTA solution to strip the adsorbed Nd (III) ions and regenerate the adsorbent for the next cycle. Both imprinted polymers exhibited good reusability, maintaining high sorption capacities after multiple cycles. AUCH-D showed an initial sorption capacity of 58.05 mg/g, which slightly decreased to 42.06 mg/g after the fifth cycle, retaining 72.4% of its initial capacity. Similarly, AUCH-G displayed an initial sorption capacity of 47.91 mg/g, reduced to 36.58 mg/g after the fifth cycle, preserving 76.3% of its original capacity. The slight decrease in sorption capacity can be attributed to the reduction of binding sites following regeneration or the incomplete desorption of Nd (III) ions during the elution process.

pH-Dependent Sorption Behavior: The distinct pH-dependent sorption profiles of AUCH-D and AUCH-G stem from their unique crosslinking mechanisms. The superior sorption performance AUCH-D in acidic media can be attributed to the efficient crosslinking of DEO. The highly reactive epoxy groups of DEO form stable crosslinks between chitosan chains, maintaining structural integrity in low pH environments. Conversely, AUCH-G exhibits enhanced sorption in alkaline conditions, likely due to glutaraldehyde's polymerization via aldol reactions and condensation, resulting in longer, irregular chains. This complex structure preserves the accessibility of imprinted sites in alkaline media but compromises stability under acidic conditions.

Influence of Alkali/Urea Dissolution on Imprinted Polymer Performance: The alkali/urea aqueous solvent system offers distinct advantages over traditional acid dissolution methods for chitosan-based imprinted polymers. This approach preserves chitosan's original structure and native functional groups while enabling complete dissolution, leading to an extended chain conformation and a unique nanofibrous network upon regeneration. The resulting hydrogels demonstrate enhanced mechanical strength, pH stability, and sorption capacity. Specific interactions between alkali species and chitosan's acetyl and amino groups, combined with urea's hydrogen bonding and stabilizing effects, create an optimal environment for efficient imprinting and selective coordination of rare earth ions like neodymium.

Synergistic Effects of Dissolution Method and Crosslinking Mechanisms: The alkali/urea dissolution synergistically enhances the distinct crosslinking mechanisms of DEO and glutaraldehyde. By promoting an extended chain conformation, deprotonating amino groups, and preserving acetyl groups, this method creates favorable conditions for efficient crosslinking reactions and the formation of stable, accessible imprinted binding sites. The resulting uniform network structure may contribute to homogeneous crosslink distribution, further improving the ion-imprinted polymers' properties. This synergy likely accounts for the significant difference in sorption capacity between imprinted and non-imprinted polymers, underscoring the effectiveness of the Nd (III) imprinting process. The expected sorption mechanism for both AUCH-G and AUCH-D, as influenced by their crosslinking structures and pH conditions, is illustrated in FIGS. 10A and 10B.

Novel chitosan imprinted polymers were successfully prepared via alkaline/urea dissolution process for the selective extraction of Nd (III) from mine waste leachate. AUCH-G and AUCH-D were formed by crosslinking glutaraldehyde and 1,2,7,8-diepoxyoctane, respectively. The materials exhibited excellent stability in harsh conditions, in addition to high sorption capacities for Nd (III). The synergistic effects of alkali/urea dissolved chitosan with each crosslinker resulted in pH-dependent performance: AUCH-G exhibited higher sorption capacities in alkaline media, while AUCH-D excelled in acidic solutions. This combination of unique crosslinking mechanisms and the advantageous structure of alkali/urea-dissolved chitosan produced highly effective ion-imprinted polymers across a wide pH range. Both hydrogels exhibited excellent selectivity, particularly in real mine waste samples. These findings highlight the potential of alkali/urea-dissolved chitosan-based imprinted polymers for the efficient recovery of rare earth elements from complex aqueous solutions.

### Example 2: Investigation of Dual-Template AUCH Systems for Simultaneous Selective

### Recovery of Pr(III) and Nd(III)

Materials and Methods: Neodymium (III) chloride hexahydrate (99.9% trace metals basis), praseodymium (III) chloride hexahydrate (99.9% trace metals basis), glutaraldehyde (50 wt % in water), 1,2,7,8-diepoxyoctane (DEO, 97%), and low molecular weight chitosan (deacetylated chitin) were all purchased from Sigma-Aldrich (St. Louis, MO, USA). Lithium hydroxide (anhydrous powder), potassium hydroxide (pellets), urea (certified ACS), and ethylenediaminetetraacetic acid (EDTA, ACS reagent) were obtained from Fisher Scientific (Hampton, NH, USA). All chemicals were used without further purification. Ultrapure Milli-Q 18.2 MΩ-cm deionized water was used throughout experiments.

Synthesis of Dual-Template Alkali/Urea Chitosan Ion-Imprinted Hydrogel: An aqueous solution containing LiOH/KOH/Urea/H2O in a weight ratio of 4.5:7:8:70 was prepared as a solvent for chitosan dissolution under stirring. Chitosan (5% w/w) was added to the slurry and mixed extensively before freezing at −30° C. overnight. Three different dual-template imprinting solutions were prepared with varying Nd:Pr ratios (1:1, 2:1, and 4:1), accounting for observed concentration disparities in PrCl₃ solutions. Each imprinting solution was individually added to separate batches of thawed chitosan slurry and mixed thoroughly. The prepared slurries were centrifuged at 10,000 rpm for 5 min at 5° C. to remove bubbles and impurities, followed by an additional mixing process. The transparent chitosan solutions were then spread on glass plates and cast to a thickness of 100 μm using a casting knife. Immediately after casting, the glass plates were transferred to a hot water bath maintained at 40° C. and soaked for 30 min, allowing the formation of the Nd/Pr dual-imprinted chitosan polymers.

Extraction Performance Evaluation: Sorption experiments were conducted in batch to assess the performance of the dual-template AUCH materials. Adsorbents were added to 50 mL of solution in sealed containers, mixing at a constant rate of 80 rpm. The impact of pH on sorption was investigated from pH 3 to 7, with adjustments made using 1.0M HCl and NaOH solutions. Kinetic studies tracked sorption over a 24-hour period at optimal pH (pH=4), with initial Nd:Pr concentrations of 50 mg/L each. Isotherm experiments were performed at optimal pH across a concentration range of 10-75 mg/L Nd:Pr. Both kinetic and isotherm studies were done at various temperatures, using a temperature-controlled water bath. To evaluate selectivity, multi-component solutions containing 50 mg/L each of Nd(III), Pr(III), La(III), Sm(III), Eu(III), Dy(III), and Tb(III) were used at optimum pH. Regeneration capabilities were assessed through five consecutive sorption-desorption cycles, using 0.05 M EDTA as the eluent. After each sorption period, samples were filtered through 0.45 μm membranes and acidified with 2% HNO₃ for analysis. Metal ion concentrations were determined using ICP-OES.

Sample Characterization and Analysis: The dual-template AUCH materials were characterized by the following instruments. Surface morphology and elemental composition were examined via ESEM (FEI Quanta 600F) with EDS capabilities. Structural analysis and functional group identification were performed using FTIR-ATR spectroscopy (Nicolet 4700). Thermal properties were assessed through DSC-TGA (SDT 600) under nitrogen atmosphere. For quantitative analysis of lanthanide concentrations, an ICP-OES (Thermo Fischer iCAP PRO) was employed, with optimized parameters for adjacent lanthanide detection. Sample preparation involved acidification and filtration, while analysis utilized matrix-matched standards and inter-element corrections to ensure accuracy.

Results. Characterization. SEM: The morphology of the dual-templated NdPr-AUCH polymers were investigated using scanning electron microscopy (SEM). The three polymers exhibit predominantly similar characteristics with smooth surfaces and minor textural features including shallow depressions and protrusions. As Nd:Pr loading increases, a slight progression in surface texture becomes apparent. NdPr-AUCH-11 displays the most uniform surface among the samples. While, NdPr-AUCH-21 and NdPr-AUCH-41 show a subtle progressive increase in surface roughness and textural elements. Unlike the significant morphological differences observed between differently crosslinked AUCH materials in previous studies, these dual-templated polymers maintain relatively consistent morphology regardless of template ratio. This morphological consistency suggests that varying the Nd:Pr template ratio within the dual-templated system does not substantially alter the overall polymer organization during synthesis, though the minor textural progression may contribute to the selective binding properties observed in sorption experiments.

FTIR: In various instances the broad band observed around 3400-3500 cm⁻¹ is attributed to overlapping O—H and N—H stretching vibrations, characteristic of the chitosan backbone. Distinctive peaks at approximately 1150, 1650, and 1750 cm⁻¹ correspond to various functional groups including C—O—C stretching of the glycosidic linkage, C═O stretching of amide I, REE-O interactions, and C—O stretching vibrations, respectively. The relative intensities of these peaks show a systematic variation with template loading, with NdPr-AUCH-41 exhibiting the strongest absorbance across these bands. The spectral region between 500-700 cm⁻¹ reveals characteristic N—H bending vibrations. The most significant spectral differences appear in the fingerprint region (1000-1500 cm⁻¹), where imprinted materials show more defined and intense bands, confirming incorporation of both Nd(III) and Pr(III) ions into the polymer matrix.

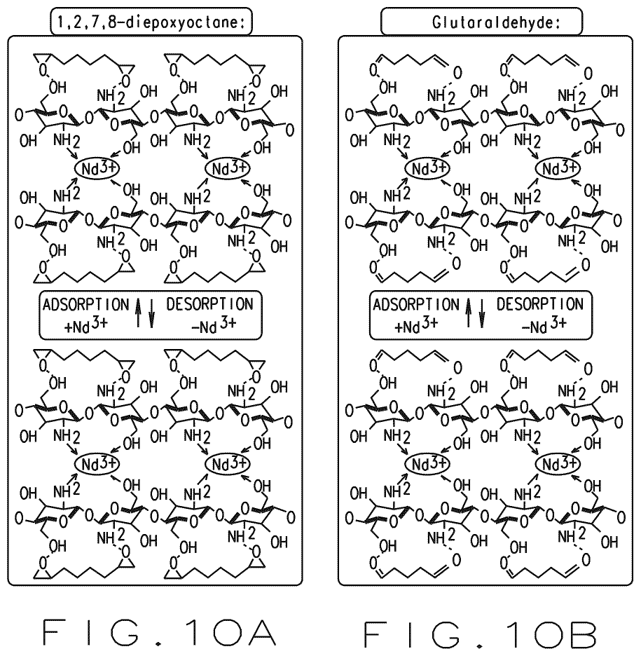

TGA: Thermogravimetric analysis was performed to evaluate the thermal stability and decomposition behavior of the dual-templated NdPr-AUCH materials (FIG. 11). All samples exhibited a multi-stage decomposition pattern, with initial weight loss (>200° C.) corresponding to the evaporation of bound water molecules from the chitosan network. Decomposition of the chitosan polymer structure occurred in the range 200-400° C. Beyond 400° C., the thermal behaviors diverged significantly based on template loadings. NdPr-AUCH-41 demonstrated the highest residual mass (˜30% at 1000° C.), followed by NdPr-AUCH-21 (˜18% at 1000° C.), while NdPr-AUCH-11 and the control polymer showed more complete decomposition (˜5% and ˜0.5% residual mass at 1000° C., respectively). This systematic increase in residual mass correlates directly with increasing REE content within the hydrogel, indicating that higher Nd:Pr loadings enhance structural stability.

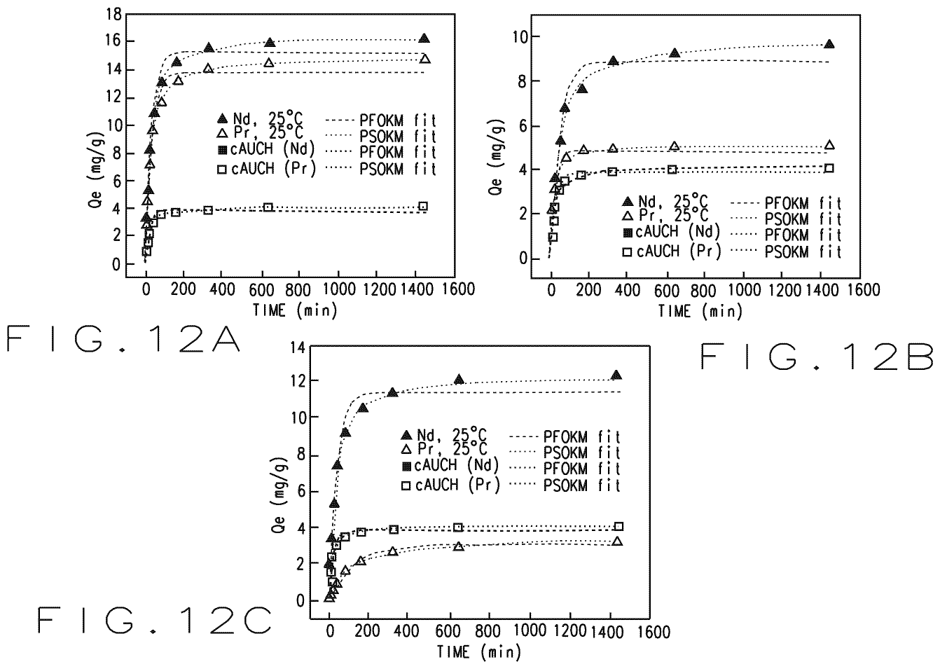

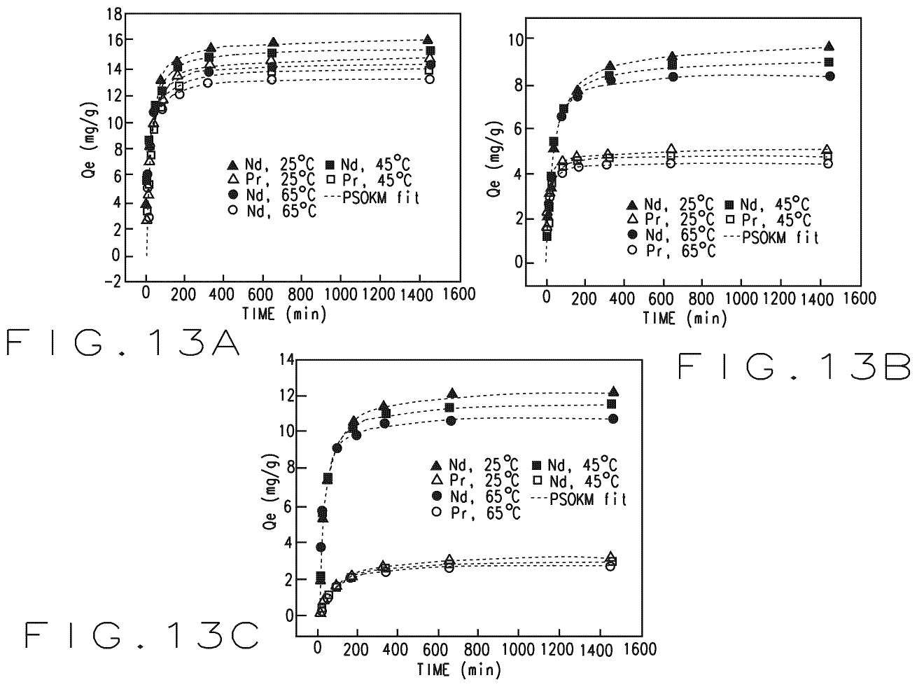

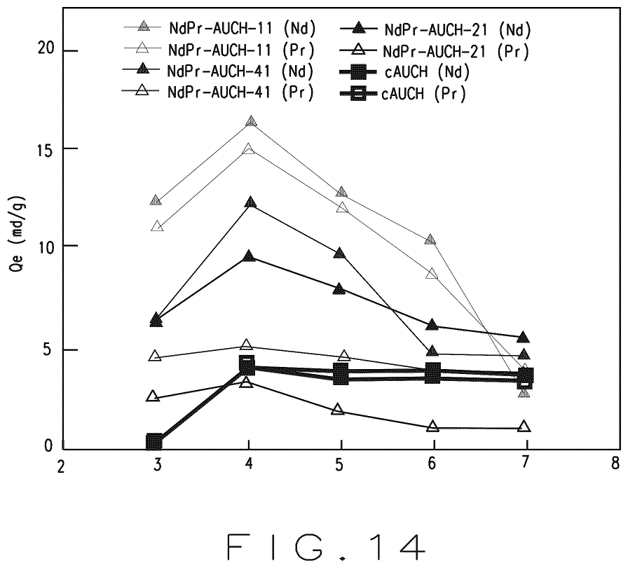

Efficiency of Nd (III) Extraction by IIPS. Kinetics: Temperature-dependent kinetic studies (25° C., 45° C., and 65° C. at pH=4) of simultaneous co-sorption of Nd(III) and Pr(III) onto the dual-templated AUCH materials reveal distinct sorption mechanisms that reflect their templating ratios. As shown in FIGS. 12A, 12B and 12C, all materials exhibited rapid initial uptake, with equilibrium times varying based on template loading. The NdPr-AUCH-11 achieved the highest total REE loading, with maximum capacities of 16.17 mg/g for Nd(III) and 14.75 mg/g for Pr(III) at 25° C., demonstrating nearly balanced simultaneous uptake. The NdPr-AUCH-21 and NdPr-AUCH-41 displayed increasingly selective Nd(III) binding, with Nd:Pr uptake closely approaching their design ratios (FIGS. 13A, 13B and 13C). Both pseudo-first-order (PFOKM) and pseudo-second-order (PSOKM) kinetic models were applied to the experimental data. The PSOKM demonstrated superior fits across all systems and temperatures (R²>0.996), indicating chemisorption-controlled processes. The pseudo-second-order rate constant (k₂) increased with temperature for all systems, suggesting faster initial sorption rates at elevated temperatures.

Activation parameters provided mechanistic insights into the binding processes. Activation energies (Ea) ranged from 9.44 to 12.38 kJ/mol, with Pr(III) consistently showing slightly higher values than Nd(III) across all materials. The negative activation entropy (ΔS) values (ranging from −260.79 to −270.41 J/mol·K) indicate increased ordering during complex formation, consistent with inner-sphere coordination mechanisms. The Gibbs free energy of activation (ΔG) increased with temperature for all systems, ranging from 87.41 to 98.24 kJ/mol, characteristic of chemical binding rather than physical sorption.

The effect of solution pH on the sorption performance of dual-templated AUCH materials was investigated across a pH range of 3-7 (FIG. 14). All imprinted polymers demonstrated pH-dependent sorption behavior, with maximum capacities observed at pH 4 and a notable decrease in sorption capacity above pH 5. NdPr-AUCH-11 achieved the highest total REE uptake with simultaneous peak sorption capacities of 16.5 mg/g for Nd(III) and 15.2 mg/g for Pr(III). All materials maintained their designed selectivity ratios most effectively between pH 3-5, with deviation outside that range. At optimal pH, the control polymer showed significantly lower sorption capacities for Nd(III) and Pr(III) in all cases, except Pr(III) sorption onto NdPr-AUCH-41.

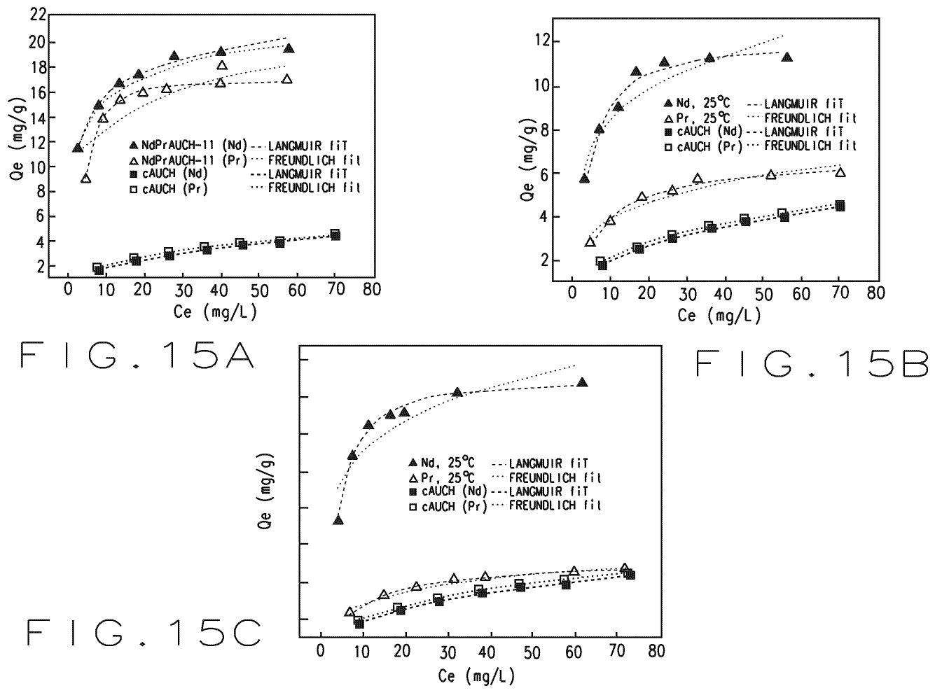

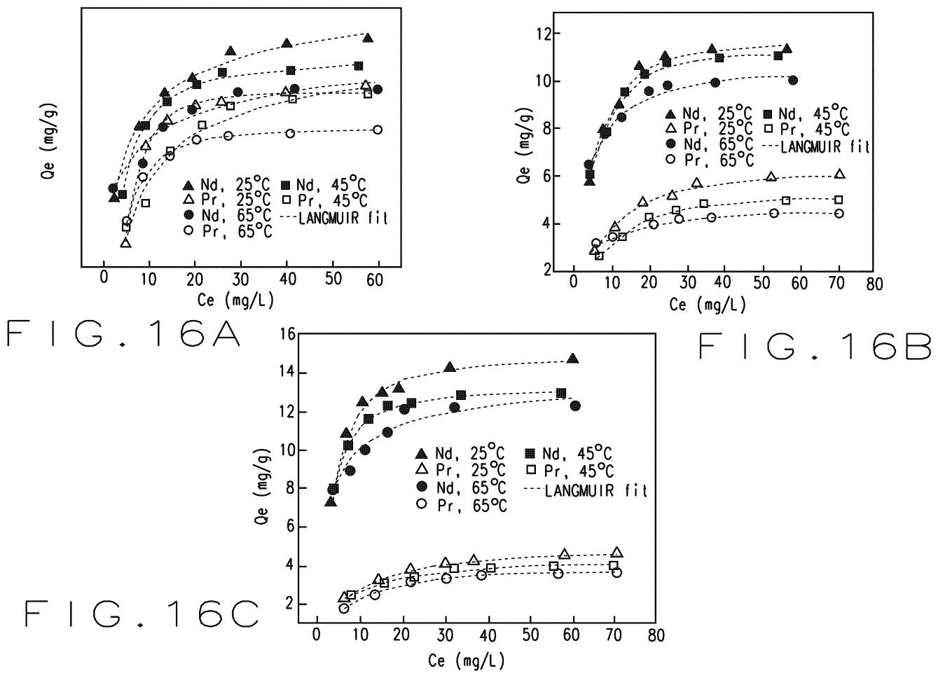

Sorption Isotherm: The sorption isotherms for Nd(III) and Pr III) onto the dual-templated AUCH materials were investigated at 25° C., 45° C., and 65° C. The experimental data were fitted with both Langmuir and Freundlich isotherm models. At 25° C., NdPr-AUCH-11 demonstrated the highest maximum sorption capacities, achieving 19.56 mg/g for Nd(III) and 17.24 mg/g for Pr(III), maintaining a ratio close to its 1:1 templating design (FIGS. 15A, 15B and 15C). NdPr-AUCH-21 exhibited maximum capacities of 11.40 mg/g and 6.15 mg/g for Nd(III) and Pr(III) respectively, while NdPr-AUCH-41 showed values of 14.83 mg/g and 4.80 mg/g. FIGS. 16A, 16B and 16C shows sorption capacities decreased as temperature increased across all materials. The Langmuir model provided a better fit across all temperatures and materials, suggesting monolayer sorption on homogenous binding sites.

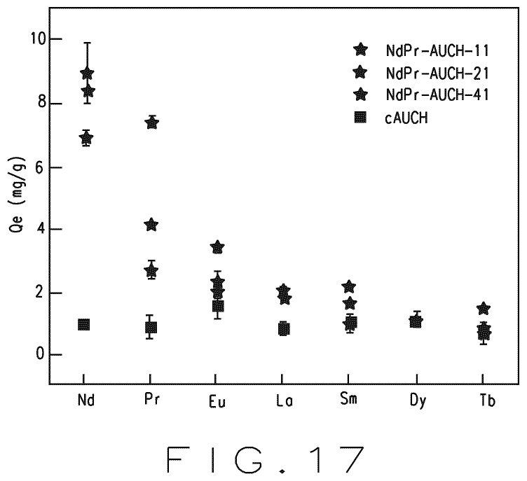

Competitive Sorption: The selective recognition capabilities of dual-templated AUCH materials for Nd(III) and Pr(III) were evaluated through competitive sorption experiments in the presence of multiple lanthanide ions. Each polymer was added to a solution containing Nd(III), Pr(III), Eu(III), La(III), Sm(III), Dy(III), and Tb(III) (50 mg/L each, pH=4) to assess selectivity performance. As shown in FIG. 17, NdPr-AUCH-11 demonstrated the highest overall sorption capacity for both target ions, achieving 8.9±0.9 mg/g for Nd(III) and 7.5±0.2 mg/g for Pr(III). NdPr-AUCH-21 showed preferential sorption of Nd(III) over Pr(III), yielding an Nd:Pr ratio of 1.7:1, while NdPr-AUCH-41 exhibited the most pronounced selectivity with 8.4±0.5 mg/g for Nd(III) and only 2.7±0.3 mg/g for Pr(III), resulting in a ratio of 3.0:1. All imprinted polymers displayed significantly lower affinities for the competing lanthanide ions, while cAUCH showed minimal sorption capacities for all lanthanide ions and no selective uptake pattern. Notably, Eu(III) showed slightly higher non-specific binding across all polymers compared to other competing ions.

Reusability Studies: The practical application of ion-imprinted polymers for REE recovery requires reliable performance over multiple sorption-desorption cycles. To evaluate this aspect, five consecutive sorption-desorption cycles at an initial concentration of 50 mg/L for both Nd(III) and Pr(III) (pH=4) were conducted for the dual-templated NdPr-AUCH materials. Following each sorption cycle, the materials were eluted with 0.05 M EDTA solution to strip the adsorbed REEs and regenerate the adsorbents for subsequent use. All three NdPr AUCH materials demonstrated decent reusability, maintaining significant sorption capacity after multiple cycles. NdPr-AUCH-11 exhibited the highest retention of initial capacity, preserving 66.8% for Pr(III) and 66.6% for Nd(III) after five cycles. NdPr-AUCH-21 showed similar durability with 65.8% retained capacity for Pr(III) and 66.0% for Nd(III), while NdPr-AUCH-41 demonstrated 75.3% retention for Pr(III) and 67.9% for Nd(III).

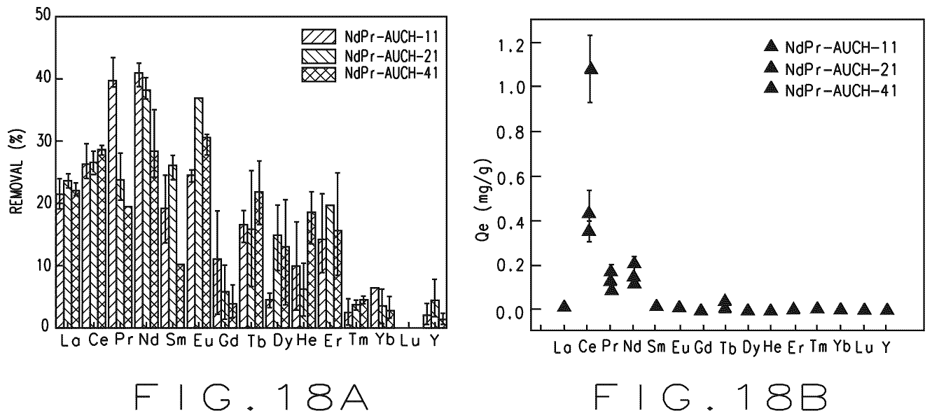

Mine Waste: The dual-templated NdPr-AUCH materials were evaluated for their effectiveness in removing rare earth elements from actual mine waste samples to assess practical applicability. FIGS. 18A and 18B illustrates the REEs percentage removal and sorption capacity achieved by the three NdPr AUCH materials. Unlike the high selectivity observed in controlled laboratory conditions, the materials demonstrated more complex behavior when applied to the multi-element mine waste matrix. All three formulations showed notable removal of the target elements, with NdPr-AUCH-11 achieving 39.5% removal of Pr(III) and 41.1% removal of Nd(III), the highest among the tested materials. NdPr-AUCH-21 demonstrated 24.1% and 38.2% removal for Pr(III) and Nd(III) respectively, while NdPr-AUCH-41 achieved 19.3% Pr(III) and 28.3% Nd(III) removal. Interestingly, all AUCH materials showed substantial removal of other light REEs (cerium, samarium, europium), despite each element not being a template ion. The high initial concentration of cerium in the mine waste (˜5× higher than Nd(III) or Pr(III)) appears to have saturated available binding sites, reducing selectivity for the target elements. The selectivity for target elements diminished in the presence of high cerium concentrations, particularly for NdPr-AUCH-41, where templated Nd(III) & Pr(III) uptake was only a fraction of the 1.08 mg/g Ce (III) sorption. This performance contrast between controlled laboratory conditions and real mine waste applications highlights the challenges of selective REE recovery from complex environmental matrices. This trend suggests that template ratios may not necessarily translate to better performance in complex real-world matrices.

TABLE 3
Nd: Pr Qe Ratios per NdPr-AUCH materials

| Test | Material | Temperature | Nd: Pr Qe Ratio |
|---|---|---|---|
| Kinetics | NdPr-AUCH-11 | 25° C. | 1.10 |
| | NdPr-AUCH-21 | | 1.89 |
| | NdPr-AUCH-41 | | 3.79 |
| | NdPr-AUCH-11 | 45° C. | 1.09 |
| | NdPr-AUCH-21 | | 1.83 |
| | NdPr-AUCH-41 | | 3.78 |
| | NdPr-AUCH-11 | 65° C. | 1.08 |
| | NdPr-AUCH-21 | | 1.87 |
| | NdPr-AUCH-41 | | 3.83 |
| pH | NdPr-AUCH-11 | 25° C. | 1.09 |
| | NdPr-AUCH-21 | | 1.85 |
| | NdPr-AUCH-41 | | 3.63 |
| Isotherm | NdPr-AUCH-11 | 25° C. | 1.14 |
| | NdPr-AUCH-21 | | 1.85 |
| | NdPr-AUCH-41 | | 3.09 |
| | NdPr-AUCH-11 | 45° C. | 1.08 |
| | NdPr-AUCH-21 | | 2.18 |
| | NdPr-AUCH-41 | | 3.18 |
| | NdPr-AUCH-11 | 65° C. | 1.13 |
| | NdPr-AUCH-21 | | 2.24 |
| | NdPr-AUCH-41 | | 3.32 |
| Competitive | NdPr-AUCH-11 | 25° C. | 1.20 |
| Sorption | NdPr-AUCH-21 | | 1.67 |
| | NdPr-AUCH-41 | | 3.07 |
| Mine Waste | NdPr-AUCH-11 | 25° C. | 0.85 |
| | NdPr-AUCH-21 | | 0.91 |
| | NdPr-AUCH-41 | | 2.36 |

Discussion Correlation Between Template Loading and Selective Sorption Performance: The dual-template AUCH materials demonstrated selective sorption of Nd(III) and Pr(III) in ratios that closely mirrored their synthesized template loadings under controlled laboratory conditions (Table 3). The preservation of these ratios in competitive binding experiments is particularly noteworthy given the chemical similarities between Nd(III) and Pr(III). The SEM analysis revealed only minor morphological differences between materials, suggesting that template ratio modulation does not significantly alter the polymer architecture. Instead, the selectivity likely stems from the precise spatial arrangement of functional groups within the binding cavities, calibrated to accommodate specific Nd:Pr proportions. This interpretation is supported by FTIR analysis. The correlation between template ratio and selectivity persisted across pH 4-5, indicating that the recognition mechanism is robust within acidic conditions.

Despite consistent template-driven selectivity observed in controlled studies, the application to complex mine waste matrices revealed practical limitations. In these experiments, the targeted Nd:Pr uptake ratios were disrupted, particularly in the presence of high concentrations of competing REE ions. This performance discrepancy between synthetic solutions and real mine waste highlights an important limitation: when competing ion concentrations significantly exceed those of target elements, binding site saturation can occur, compromising the templated selectivity. This suggests that practical applications of these materials depend on specific waste streams and may require preliminary treatment steps to reduce competing ion concentrations. The approach may be more suitable for later-stage REE processing streams where the matrix complexity has been reduced.

Mechanistic Insights from Thermodynamic and Kinetic Parameters: The thermodynamic and kinetic parameters extracted from temperature-dependent studies provide valuable insights into the sorption mechanisms of Nd(III) and Pr(III) onto dual-template AUCH materials. The consistently lower energy requirements for Nd(III) binding compared to Pr(III) across all materials suggests an intrinsic coordination preference, likely stemming from hydration energetics. This energy differential becomes increasingly significant at higher Nd:Pr template ratios, suggesting that the templating process amplifies natural binding preferences through optimized cavity geometries. The activation parameters point toward a coordination-driven recognition mechanism where differences in hydration energy and electronic configuration influence binding efficiency. The energetic advantage for Nd(III) binding provides the thermodynamic foundation for maintaining template ratio fidelity during simultaneous sorption. These findings suggest potential for further refinement of lanthanide separation strategies based on targeted amplification of small energy differences between chemically similar elements. By precisely engineering binding cavity environments that maximize these energetic differentials, more challenging separations might be achieved.

Alkali/Urea Dissolution System's Role in Adjacent Lanthanide Discrimination: Traditional chitosan-based materials often struggle to differentiate between chemically similar elements due to heterogeneous binding site distribution and dominant electrostatic interactions. This challenge is overcome in the alkali/urea system, where the disruption of hydrogen bonds during dissolution and subsequent controlled reformation during gelation creates a more homogeneous network structure with uniform binding site distribution. This restructuring process creates a molecular environment where coordination chemistry can dominate separation processes, enabling the materials to leverage subtle differences in lanthanide electronic structures and complex formation preferences. The minimal surface charge characteristic of alkali/urea dissolved chitosan creates a binding environment where small differences in coordination energetics are less affected by non-specific electrostatic attractions. The dual-templating approach demonstrates our ability to engineer binding environments with predetermined selectivity patterns, despite inherent performance trade-offs. While this system demonstrated ratio-controlled extraction of adjacent lanthanides, our previous single-template AUCH materials exhibited higher absolute selectivity coefficients and superior regeneration performance over multiple cycles, suggesting that competition between closely related lanthanides for optimized binding sites introduces additional complexity in the coordination environment.

As various changes could be made in the above constructions without departing from the scope of the invention, it is intended that all matter contained in the above description or shown in the accompanying drawings shall be interpreted as illustrative and not in a limiting sense.

1. A crosslinked ionic imprinted polymer (IIP) for the selective extraction of rare earth metals, the crosslinked IIP synthesized by a method comprising the steps of:
dissolving chitosan in an alkaline solution to create a dissolved chitosan solution;
freezing and then thawing the dissolved chitosan solution;
adding an imprinting solution to the dissolved chitosan solution to form an ionic imprinted solution;
casting the ionic imprinted solution to obtain an IIP; and
adding a crosslinker to the IIP to create a crosslinked IIP.

2. The crosslinked IIP of claim 1 wherein the alkaline solution is a mixture of one or more bases, urea, and water in a weight ratio of 11.5:8:70.

3. The crosslinked IIP of claim 1 wherein the one or more strong bases comprise LiOH and KOH in a ratio of 4.5:7.

4. The crosslinked IIP of claim 1 wherein the IIP is cast to a thickness between 50 and 200 μm.

5. The crosslinked IIP of claim 1 wherein the crosslinker is a bifunctional crosslinker.

6. The crosslinked IIP of claim 5 wherein the crosslinker is a homobifunctional electrophilic crosslinker.

7. The crosslinked IIP of claim 5 wherein the crosslinker is glutaraldehyde or 1,2,7,8-diepoxyoctane.

8. The crosslinked IIP of claim 1 wherein the crosslinked IIP is exposed to a chelating agent to remove the source of rare earth metals.

9. The crosslinked IIP of claim 8 wherein the chelating agent is ethylenediaminetetraacetic acid (EDTA).

10. The crosslinked IIP of claim 1 wherein the imprinting solution comprises praseodymium, dysprosium, terbium, or neodymium.

11. The crosslinked IIP of claim 10 wherein the imprinting solution comprises NdCl₃.6H₂O.

12. A method of synthesizing a crosslinked ionic imprinted polymer, the method comprising the steps of:
dissolving chitosan in an alkaline solution to create a dissolved chitosan solution;
freezing and then thawing the dissolved chitosan solution;
adding an imprinting solution to the dissolved chitosan solution to form an imprinted polymer solution;
casting the imprinted polymer solution to obtain an imprinted polymer; and
adding a crosslinker to the imprinted polymer to create a crosslinked imprinted polymer.

13. The method of claim 12 wherein the alkaline solution is a mixture of one or more strong bases, urea, and water in a weight ratio of 11.5:8:70.

14. The method of claim 12 wherein the one or more strong bases comprise LiOH and KOH in a ratio of 4.5:7.

15. The method of claim 12 wherein the crosslinker is a bifunctional crosslinker.

16. The method of claim 15 wherein the crosslinker is a homobifunctional electrophilic crosslinker.

17. The method of claim 15 wherein the crosslinker is glutaraldehyde or 1,2,7,8-diepoxyoctane.

18. A crosslinked ionic imprinted polymer (IIP) for the selective extraction of rare earth metals, the crosslinked IIP comprising:
a polymer structure, wherein the polymer structure comprises: repeating, covalently bonded chitosan monomer units; and
a plurality of binding sites, the binding sites being voids sized to selectively receive and hold one or more rare earth elements,
wherein the polymer structure is reinforced by one or more chemical crosslinkers such that the crosslinked IIP does not dissolve in water.
